(19) United States
(12) Patent Application Publication
(10) Pub. No.: US 2026/0355714 A1
(43) Pub. Date: Nov. 12, 2026

(54) LITHIUM ADSORBENT AND PREPARATION METHOD THEREFOR

(71) Applicant: BYD COMPANY LIMITED, Shenzhen (CN)

(72) Inventors: Teng LI, Shenzhen (CN); Minghao WANG, Shenzhen (CN); Junlan LIAN, Shenzhen (CN); Hongye LIN, Shenzhen (CN)

(21) Appl. No.: 19/712,789

(22) Filed: Jun. 18, 2026

Related U.S. Application Data
(63) Continuation of application No. PCT/CN2024/119699, filed on Sep. 19, 2024.

(30) Foreign Application Priority Data
Dec. 21, 2023 (CN) 202311777154.7

(51) Int. Cl. B01J 20/08; B01J 20/32

(52) U.S. Cl. CPC B01J 20/08; B01J 20/3208

(57) ABSTRACT

The present disclosure provides a lithium adsorbent and a preparation method therefor. On the basis of the special morphology and size design of the tubular lithium adsorbent, the lithium adsorbent has good adsorption capacity, desorption capacity, adsorption rate and desorption rate as well as excellent magnesium-lithium sieving rate, and also has good structural strength; thus, the lithium adsorbent has long service life and low pulverization rate.

The present disclosure is a bypass continuation of International Patent Application No. PCT/CN2024/119699, which in turn claims priority to Chinese Patent Application No. 202311777154.7, filed with the China National Intellectual Property Administration on Dec. 21, 2023 and entitled “LITHIUM ADSORBENT AND PREPARATION METHOD THEREFOR,” both of which are hereby incorporated herein by reference in their entireties for all purposes.

### TECHNICAL FIELD

The present disclosure relates to the technical field of lithium adsorbents, and specifically, to a lithium adsorbent and a preparation method therefor.

### BACKGROUND

Lithium has a strong ability to gain and lose electrons, making it one of the important raw materials for battery materials. With the development of the new energy industry, the global demand for lithium has increased sharply. Lithium exists in nature mainly in two forms: one is in a form of lithium ore, and the other is in a form of lithium ions in brine such as salt lake brine. China has a large reserve of lithium resources in salt lakes, but generally suffers from a problem of an excessively high magnesium-to-lithium ratio. Therefore, large-scale development and application have not been achieved. In recent years, a process for extracting lithium from salt lake brine with a high magnesium-to-lithium ratio by using an adsorption method has been widely favored. However, a technical difficulty of the process lies in developing a lithium adsorbent with excellent performance. Currently, lithium adsorbent particles commonly used in industry generally have high strength but limited adsorption/desorption effect, or have an acceptable adsorption/desorption capacity but suffer from low strength, a high pulverization rate, and a short service life.

### SUMMARY

In view of this, embodiments of the present disclosure provide a lithium adsorbent and a preparation method therefor. Based on the special morphology and size design of the lithium adsorbent, the lithium adsorbent has a good adsorption capacity, desorption capacity, adsorption rate, desorption rate, and an excellent magnesium-lithium sieving rate, but also has good structural strength. Consequently, the lithium adsorbent has a long service life and a low pulverization rate.

A first aspect of the embodiments of the present disclosure provides a lithium adsorbent. The lithium adsorbent is tubular and includes a skeleton structure and one or more channels running in a length direction thereof. An inner diameter of the channel is 0.1 mm to 0.7 mm, and a wall thickness of the lithium adsorbent is 0.2 mm to 1 mm. The skeleton structure of the lithium adsorbent includes a polymer matrix and adsorbent particles dispersed in the polymer matrix.

In the lithium adsorbent, the adsorbent particles are dispersed in the polymer matrix, which can reduce a risk of pulverization and detachment of the adsorbent particles, to prolong a service life of the lithium adsorbent to some extent. In addition, the lithium adsorbent has a proper inner diameter of the channel, which can induce brine to wet and fill the channels to fully interact with the adsorbent particles, thereby significantly improving adsorption efficiency and magnesium-lithium sieving rate of the lithium adsorbent. In addition, a proper wall thickness can improve structural strength of the lithium adsorbent and further reduce a pulverization rate, thereby improving cycling performance and prolonging the service life of the lithium adsorbent. Therefore, the lithium adsorbent can achieve high lithium ion adsorption/desorption efficiency, good magnesium-lithium sieving rate, and a long cycling service life.

A second aspect of the embodiments of the present disclosure provides a preparation method for a lithium adsorbent, including: mixing a polymer matrix, adsorbent particles, and a solvent to obtain a first material; and placing the first material and a second material in an accommodating cavity of a spinning device, and performing spinning based on a preset size by using a coaxial spinning process, so that the first material and the second material serving as a core liquid are coaxially extruded to obtain an initial fiber, where the second material includes a substance that is non-coagulable during a spinning process; and performing a coagulation treatment and cutting on the initial fiber to obtain the lithium adsorbent.

The preparation method has simple steps, high process reliability, high process flexibility, and high production efficiency, and is suitable for large-scale industrial production.

### BRIEF DESCRIPTION OF DRAWINGS

FIG. 1A is a schematic diagram of a structure of a cross section of a lithium adsorbent according to an embodiment of the present disclosure;

FIG. 1B is a schematic diagram of a structure of a longitudinal section of the lithium adsorbent in FIG. 1A;

FIG. 2 is a schematic diagram of a structure of a cross section of a lithium adsorbent according to another embodiment of the present disclosure;

FIGS. 3 (a), (b), and (c) are scanning electron microscope (SEM) photos illustrating an outer surface of a lithium adsorbent according to Example 3 at different magnifications;

FIGS. 4 (a), (b), and (c) are SEM photos illustrating a cross section of a lithium adsorbent according to Example 3 at different magnifications;

FIGS. 5 (a) and (b) are SEM photos illustrating a surface of a lithium adsorbent according to Example 3 facing a channel at different magnifications;

FIG. 6 is an SEM photo illustrating a cross section of a lithium adsorbent according to Example 5;

FIG. 7 is a pulverization test result of a lithium adsorbent according to Example 3 in water;

FIG. 8 is a pulverization test result of a lithium adsorbent according to Comparative Example 1 in water; and

FIG. 9 is a pulverization test result of a lithium adsorbent according to Comparative Example 2 in water.

Description of reference numerals: 100: Lithium adsorbent; 10: Skeleton structure; 11: Polymer matrix; 12: Adsorbent particle; 20: Channel

### DESCRIPTION OF EMBODIMENTS

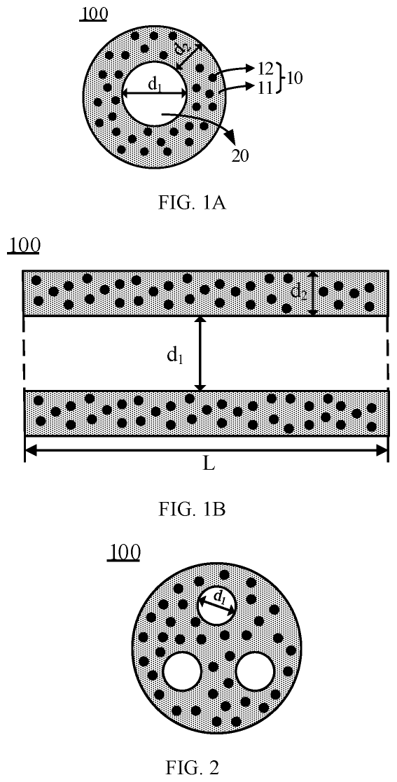

To simultaneously improve adsorption/desorption effect and prolong a service life of a lithium adsorbent, an embodiment of the present disclosure provides a lithium adsorbent. Specifically, referring to FIG. 1A to FIG. 2, a lithium adsorbent 100 provided in this embodiment of the present disclosure is tubular and includes a skeleton structure 10 and one or more channels 20 running in a length direction thereof. An inner diameter (d₁) of the channel 20 is 0.1 mm to 0.7 mm, and a wall thickness (d₂) of the lithium adsorbent is 0.2 mm to 1 mm. The skeleton structure 10 includes a polymer matrix 11 and adsorbent particles 12 dispersed in the polymer matrix 11. It should be noted that FIG. 1A to FIG. 2 are example structural diagrams, and distribution positions, a quantity, and sizes of the adsorbent particles 12 in the figures are not limited to the examples shown in the figures. A cross section is a section obtained by cutting the lithium adsorbent 100 with a plane perpendicular to a length direction of the lithium adsorbent 100. A longitudinal section is a section obtained by cutting the lithium adsorbent 100 with a plane that is parallel to the length direction of the lithium adsorbent 100 and that runs through one channel 20 of the lithium adsorbent 100.

In the lithium adsorbent 100, the adsorbent particles 12 that can implement adsorption/desorption are dispersed in the polymer matrix 11, which reduces the risk of pulverization of the adsorbent particles 12 and prolongs the service life of the lithium adsorbent 100 to some extent. When the lithium adsorbent 100 is mixed with brine, the brine may wet from an outer surface (that is, a surface of the skeleton structure 10 facing away from the channel 20) of the lithium adsorbent 100. Because the channel has a proper inner diameter, the brine is induced to wet and fill the channel 20, which facilitates brine adsorption by using a surface of the channel 20. When the brine is further stirred, the brine may flow from inner and outer surfaces and an end surface of the lithium adsorbent 100 into an interior of the lithium adsorbent 100 and then diffuse, so that the brine can smoothly wet the lithium adsorbent 100 from an inner surface (a wall of the channel 20) of the lithium adsorbent 100. Similarly, during washing and desorption processes, a rinsing liquid and a desorbent (for example, water) may also wet the lithium adsorbent 100 simultaneously from the inner and outer surfaces of the lithium adsorbent 100. In this way, an adsorption capacity and rate of the lithium adsorbent 100 during an adsorption process, a desorption capacity and rate of the lithium adsorbent 100 during a desorption process, and rinsing removal efficiency of impurity ions (for example, magnesium ions) can be significantly improved, making it easy to obtain a desorption solution with a low magnesium-to-lithium ratio and a high lithium content. In addition, due to the proper wall thickness and inner diameter, adsorption effect of the lithium adsorbent 100 can be significantly improved, and strength of the lithium adsorbent 100 can be improved to further reduce the pulverization rate, thereby significantly improving cycling performance and prolonging the service life of the lithium adsorbent 100.

For example, the inner diameter of the channel 20 may be, but is not limited to, 0.10 mm, 0.15 mm, 0.20 mm, 0.25 mm, 0.30 mm, 0.35 mm, 0.40 mm, 0.45 mm, 0.50 mm, 0.55 mm, 0.60 mm, 0.65 mm, or 0.70 mm. In consideration that brine usually has specific viscosity, if the inner diameter of the channel 20 is excessively small (<0.1 mm), it is difficult for the brine to fully wet an inner wall of the channel 20 and smoothly wet the entire channel of the lithium adsorbent 100, so that the surface of the channel 20 cannot be in contact with the brine in a short time, which seriously affects the adsorption capacity and rate. In addition, if the inner diameter of the channel 20 is excessively large (>0.7 mm), the strength of the lithium adsorbent 100 is affected, the service life of the lithium adsorbent 100 is reduced, and packing density of the lithium adsorbent 100 is reduced, which affects the adsorption effect of lithium in the brine.

In this embodiment of the present disclosure, the inner diameter (d₁) of the channel 20 is an average of maximum lateral dimensions of the channel 20 on a cross section of the lithium adsorbent 100. The cross section is a section obtained by cutting the lithium adsorbent 100 with a plane perpendicular to the length direction of the lithium adsorbent 100. For the lithium adsorbent 100 having only one channel 20, the inner diameter of the channel 20 of the tubular lithium adsorbent 100 is obtained by averaging data measured from three cross sections taken respectively at two ends and a middle position of the channel 20. For the lithium adsorbent 100 having a plurality of channels 20, dimensions of each channel 20 at the three positions are measured respectively to calculate an inner diameter of each channel 20. The inner diameter of each channel 20 needs to be within a range of 0.1 mm to 0.7 mm, and inner diameters of the plurality of channels 20 may be the same or different. In this embodiment of the present disclosure, the inner diameter of the channel 20 may be measured by using an optical microscope or a scanning electron microscope (scanning electron microscope, SEM), and the cross section of the lithium adsorbent 100 may be prepared by using a brittle fracture method.

In some implementations of the present disclosure, the skeleton structure 10 is a porous structure. In this way, the lithium adsorbent has a multi-dimensional pore structure, which can increase a specific surface area of the lithium adsorbent 100, so that brine can better penetrate the skeleton structure 10 and be in full contact with the adsorbent particles 12 dispersed in the polymer matrix 11, thereby fully exerting adsorption and desorption capabilities of the lithium adsorbent 100. Specifically, the porous structure inside the skeleton structure 10 is mainly formed by stacking the adsorbent particles 12, and the polymer matrix 11 used for adhering/fixing the adsorbent particles is located between the adsorbent particles 12, so that the specific surface area of the skeleton structure 10 can be controlled to be within a proper range. Further, a total pore volume and the specific surface area of the lithium adsorbent 100 can be controlled within proper ranges.

When the skeleton structure 10 is a porous structure, in some implementations of the present disclosure, the lithium adsorbent 100 has a BET specific surface area≥17 m²/g, for example, 17 m²/g to 22 m²/g. In the embodiments of the present disclosure, the BET specific surface area of the lithium adsorbent 100 is tested by using a gas adsorption-desorption instrument. For example, the BET specific surface area of the lithium adsorbent 100 may be, but is not limited to 17 m²/g, 17.5 m²/g, 18 m²/g, 18.5 m²/g, 19 m²/g, 19.5 m²/g, 20 m²/g, 20.5 m²/g, 21 m²/g, 21.5 m²/g, or 22.0 m²/g. It may be understood that the adsorbent particles 12 have a pore structure, so that the BET specific surface area includes specific surface areas of the channels 20, the porous structure of the skeleton structure 10, and the pore structure of the adsorbent particles 12.

In some embodiments, pores on a surface of the skeleton structure 10 facing the channel 20 and on a surface of the skeleton structure 10 facing away from the channel 20 have a pore size of 10 nm to 200 nm. In some implementations of the present disclosure, during preparation of the lithium adsorbent 100, the matrix and the adsorbent particles are both dispersed in a solvent. In this case, the pores on the surface of the skeleton structure 10 are mainly formed by the solvent precipitating out from the skeleton structure during preparation of the lithium adsorbent 100. This facilitates penetration of the brine and the desorbent, ensures good mechanical properties of the skeleton structure 10, and further reduces the pulverization rate of the adsorbent particles 12, thereby improving the mechanical properties and cycling stability of the lithium adsorbent 100. In addition, the adsorption efficiency of the lithium adsorbent 100 is ensured, the service life of the lithium adsorbent 100 is prolonged, and a magnesium-lithium selectivity ratio of the lithium adsorbent 100 is improved to some extent. For example, the pore size of the pores may be, but is not limited to, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 110 nm, 120 nm, 130 nm, 140 nm, 150 nm, 160 nm, 170 nm, 180 nm, 190 nm, 200 nm, or the like. In this embodiment of the present disclosure, the SEM may be used to characterize the pore size of the pores on the surface of the skeleton structure 10 facing the channel 20 and the surface of the skeleton structure 10 facing away from the channel 20.

In this embodiment of the present disclosure, the wall thickness of the lithium adsorbent 100 can be measured when the inner diameter of the channel 20 is measured. Specifically, for the lithium adsorbent 100 having only one channel 20, the wall thickness of the lithium adsorbent 100 is an overall average of wall thicknesses measured at any three positions on each of three cross sections taken at three different positions (two ends and a middle position) of the lithium adsorbent 100. Specifically, for the lithium adsorbent 100 having a plurality of channels 20, a minimum distance from each channel to an outer surface of the skeleton structure (a surface of the skeleton structure facing away from the channel) is measured and denoted as a, and a minimum distance between two adjacent channels is measured and denoted as b. A minimum value of a and b is taken as the wall thickness of the lithium adsorbent 100 at the cross section. A wall thickness of the lithium adsorbent 100 corresponding to each channel is within a range of 0.2 mm to 1 mm. Similarly, for the lithium adsorbent having a plurality of channels 20, there is also a need to measure wall thicknesses corresponding to different channels 20 on cross sections taken at three different positions (two ends and a middle position) of the lithium adsorbent 100. An average of three wall thicknesses corresponding to each channel 20 is taken as the wall thickness corresponding to the channel 20.

For example, the wall thickness of the lithium adsorbent 100 (d₂) may be but is not limited to 0.20 mm, 0.25 mm, 0.30 mm, 0.35 mm, 0.40 mm, 0.45 mm, 0.50 mm, 0.55 mm, 0.60 mm, 0.65 mm, 0.70 mm, 0.75 mm, 0.80 mm, 0.85 mm, 0.90 mm, 0.95 mm, 1.00 mm, or the like. A smaller wall thickness of the lithium adsorbent 100 may further facilitate diffusion of the brine, the rinsing liquid, and the desorbent within the lithium adsorbent 100. However, an excessively small thickness (<0.2 mm) of the lithium adsorbent 100 seriously affects the strength of the lithium adsorbent, and thus affects the service life of the lithium adsorbent. An excessively large thickness (>1 mm) of the lithium adsorbent 100 leads to a decrease in the adsorption/desorption rate and the adsorption/desorption capacity of the lithium adsorbent 100, as well as an increase in the residue of impurity ions (for example, magnesium ions) in the desorption solution.

In this embodiment of the present disclosure, there may be one or more channels 20 in the lithium adsorbent 100. For example, there may be two, three, four, five, six channels 20. In this embodiment of the present disclosure, when the lithium adsorbent 100 has a plurality of through channels 20, relative positions of the channels 20 are not limited, provided that a parameter corresponding to each channel meets a parameter limitation of the embodiments of the present disclosure. For example, it may be understood that the following describes distribution of a plurality of channels by means of distribution of pores of the plurality of channels 20 on an end surface of the lithium adsorbent 100. When there are three channels, pores of the three channels 20 on the end surface of the lithium adsorbent 100 may be arranged in a triangular pattern or a simple lateral arrangement. When there are four channels, pores of the four channels 20 on the end surface of the lithium adsorbent 100 may be arranged in a rectangular pattern, a rhombic pattern, or a lateral arrangement. The lateral arrangement may be a single row or a plurality of rows. Alternatively, the pores of the four channels may be arranged such that three channels surround a central pore. When there are five channels, pores of the five channels 20 on the end surface of the lithium adsorbent 100 may be arranged in a pentagonal pattern, or may be arranged such that four channels surround a central pore. Alternatively, the pores of the five channels may be arranged even in a lateral arrangement. The lateral arrangement may be a single row or a plurality of rows. A person skilled in the art may perform analogy based on the foregoing examples, and perform selection based on an actual production situation.

In some implementations of the present disclosure, a ratio of the inner diameter of the channel 20 to the wall thickness is 1:(0.3-2). In this way, the lithium adsorbent 100 can better balance the strength and the adsorption effect. The adsorption effect includes the adsorption capacity, the adsorption rate, and the magnesium-lithium selectivity ratio. For example, the ratio of the inner diameter of the channel 20 to the wall thickness may be, but is not limited to, 1:03, 1:05, 1:0.6, 1:0.8, 11:1.0, 1:1.2, 1:1.5, 1:1.6, 1:1.8, 1:2.0, or the like.

In some implementations of this disclosure, referring to FIG. 1B, a length L of the lithium adsorbent 100 is 0.5 mm to 3 mm. The length of the lithium adsorbent 100 is controlled to be within the foregoing range, so that the lithium adsorbent 100 can have a large specific surface area. This also facilitates complete wetting and filling of the channel 20 of the lithium adsorbent 100 by brine having specific viscosity, so that the lithium adsorbent 100 can fully exert the adsorption capability. In addition, this also helps increase the packing density of the lithium adsorbent 100, thereby improving lithium extraction efficiency. For example, the length of the lithium adsorbent 100 may be, but is not limited to 0.5 mm, 0.75 mm, 1.0 mm, 1.25 mm, 1.5 mm, 1.75 mm, 2.0 mm, 2.25 mm, 2.5 mm, 2.75 mm, 3.0 mm, or the like.

In some implementations of the present disclosure, the polymer matrix 11 includes but is not limited to at least one of polyvinylidene fluoride, polyvinyl butyral, polyethersulfone, polysulfone, polyacrylonitrile, polyvinyl chloride, or polyethylene. In some embodiments, the foregoing materials have some mechanical properties, which helps ensure that the strength of the lithium adsorbent 100 is high. In addition, the foregoing materials have good solubility in an organic material and have good spinnability, which helps improve production efficiency of the lithium adsorbent 100. In some embodiments, to increase an interaction force between the polymer matrix 11 and the adsorbent particles 12, and further improve structural stability of the lithium adsorbent 100, the foregoing polymers may be modified. Specifically, the modification includes, but is not limited to, copolymerization modification. For example, vinylidene fluoride monomers may be copolymerized with a small amount of acrylate monomers to obtain a vinylidene fluoride-acrylate copolymer. Certainly, another copolymerization monomer may alternatively be selected. Similarly, a person skilled in the art may select another polymer for copolymerization modification based on an actual need. Details are not described herein.

In some implementations of the present disclosure, the adsorbent particles 12 include, but are not limited to, at least one of aluminum-based adsorbent particles, titanium-based adsorbent particles, or manganese-based adsorbent particles. For example, a material of the aluminum-based adsorbent particles includes, but is not limited to, LiX·2Al(OH)₃·nH₂O (where X is an inorganic acid radical ion, and n>0) and the like. A material of the titanium-based adsorbent particles includes, but is not limited to, H₂TiO₃ ion sieve, H₄Ti₅O₁₂ ion sieve, and the like. A material of the manganese-based adsorbent particles 12 includes, but is not limited to, LiMnO₄, LiMn₂O₄, Li_{1.6}Mn_{1.6}O₄, Li_{1.33}Mn_{1.67}O₄, and the like.

In some implementations of the present disclosure, the D50 particle size of the adsorbent particles 12 is 0.01 μm to 10 μm. The D50 particle size of the adsorbent particles 12 is controlled to be within the foregoing range, so that the adsorbent particles 12 have a proper specific surface area, which facilitates adsorption/desorption of lithium ions and improves the adsorption efficiency. In addition, the adsorbent particles 12 serving as a reinforcing phase ensures good strength of the lithium adsorbent 100, and facilitates uniform dispersion of the adsorbent particles in the skeleton structure 10, thereby improving uniformity of the lithium adsorbent 100. For example, the D50 particle size of the adsorbent particles 12 may be, but is not limited to, 0.01 μm, 0.02 μm, 0.05 μm, 0.1 μm, 0.5 μm, 1 μm, 1.5 μm, 2 μm, 2.5 μm, 3 μm, 3.5 μm, 4 μm, 4.5 μm, 5 μm, 6 μm, 7 μm, 8 μm, 9 μm, 10 μm, or the like. In this embodiment of the present disclosure, the D50 particle size of the adsorbent particles may be measured by using an SEM.

In some implementations of the present disclosure, the surface of the channel 20 is modified with hydrophilic particles. In other words, the inner surface of the lithium adsorbent 100 is modified with hydrophilic particles. In this way, hydrophilicity of the inner surface (channel wall) of the lithium adsorbent 100 can be significantly improved, so that brine can more easily be in contact with and wet the inner surface of the lithium adsorbent 100, thereby promoting adsorption of brine on the inner surface of the lithium adsorbent 100, and thus improving the adsorption efficiency of the lithium adsorbent 100. In the embodiments of the present disclosure, a material of the hydrophilic particles may be any hydrophilic material known in this art. In some embodiments, the material of the hydrophilic particles is selected to be the same as the material of the adsorbent particles 12. For example, the hydrophilic particles may be selected from at least one of an aluminum-based adsorbent, a titanium-based adsorbent, or a manganese-based adsorbent, but are not limited thereto. In this case, the hydrophilic particles further have a specific adsorption capability, which further facilitates wetting of the brine and adsorption of lithium ions.

In some implementations of the present disclosure, a D50 particle size of the hydrophilic particles is 0.01 μm to 1 μm. The D50 particle size of the hydrophilic particles is controlled to be within the foregoing range, so that the hydrophilic particles can adhere well to the channel wall, which reduces a risk that the hydrophilic particles are washed away during repeated immersion in brine and flushing by a cleaning solution. In addition, the hydrophilic particles do not occupy excessive space in the channel 20, which facilitates flow of brine in the channel 20, thereby improving overall performance of the lithium adsorbent 100. For example, the D50 particle size of the hydrophilic particles may be, but is not limited to, 0.01 μm, 0.05 μm, 0.1 μm, 0.2 μm, 0.3 μm, 0.4 μm, 0.5 μm, 0.6 μm, 0.7 μm, 0.8 μm, 0.9 μm, 1 μm, or the like. In this embodiment of the present disclosure, the D50 particle size of the adsorbent particles 12 in the lithium adsorbent 100 is measured by using the SEM.

In consideration that in some implementations, the skeleton structure 10 of the lithium adsorbent 100 is prepared by first mixing the adsorbent particles 12 with an organic solution of the polymer matrix 11, to improve formability of the skeleton structure 10 and increase a total pore volume of the channels 20 in the lithium adsorbent 100, in some implementations of the present disclosure, a ratio of a total mass of the adsorbent particles 12 to a mass of the polymer matrix 11 is controlled to be 100:(9-16). In some embodiments, a ratio of a total mass of the adsorbent particles 12 to a mass of the polymer matrix 11 is 100:(12-15). In this way, hydrophilicity of the skeleton structure 10 of the lithium adsorbent 100 can be improved to some extent, and a proper pore structure can be formed in the skeleton structure 10, so that a porosity of the skeleton structure 10 (or comprehensively reflected as the total pore volume of the lithium adsorbent 100) is controlled to be within a proper range. This ensures high strength and good cycling stability of the lithium adsorbent 100, and facilitates formation of a multi-dimensional pore structure, thereby further improving the adsorption/desorption efficiency of the lithium adsorbent 100. For example, the ratio of the total mass of the adsorbent particles 12 to the mass of the polymer matrix 11 may be, but is not limited to, 100:9, 11:1, 10.5:1, 10:1, 9.5:1, 9:1, 8.5:1, 8:1, 7.5:1, 7:1, 6.5:1, 6.4:1, 6.3:1, 6.28:1, 6.25:1, or the like. In this embodiment of the present disclosure, the mass ratio of the adsorbent particles 12 to the polymer matrix 11 in the lithium adsorbent 100 may be measured by using a thermogravimetric method.

In some implementations of the present disclosure, the lithium adsorbent 100 has a compressive strength≥5 N, for example, 5 N to 6.5 N. When the compressive strength of the lithium adsorbent 100 is ≥5 N, the lithium adsorbent 100 is less prone to deformation, fracturing, or detachment of the adsorbent particles 12 when being loaded in an adsorption column during application. In this way, the lithium adsorbent 100 has good structural stability, thereby prolonging the cycling service life of the lithium adsorbent 100.

An embodiment of the present disclosure further provides a preparation method for a lithium adsorbent. The method may be used to prepare the foregoing lithium adsorbent 100, and includes the following processes.

S01: Mix a polymer matrix, adsorbent particles, and a solvent to obtain a first material.

S02: Place the first material and a second material in an accommodating cavity, and perform spinning, based on a preset size by using a coaxial spinning process, so that the first material and the second material serving as a core liquid are coaxially extruded to obtain an initial fiber, where the second material includes a substance that is non-coagulable during a spinning process, and the non-coagulable substance includes but is not limited to water; and perform a coagulation treatment and cutting on the initial fiber to obtain the lithium adsorbent.

In this embodiment of the present disclosure, coaxial spinning means that different materials are extruded from a same nozzle at the same time. It is understood that for example, when a lithium adsorbent having only one channel is prepared, a front view of the nozzle includes a first flow channel and a second flow channel that are arranged concentrically or eccentrically. The second material serving as a core liquid is extruded from the second flow channel, and the first material is extruded from space formed by the second flow channel and the first flow channel, thereby obtaining the initial fiber. The first material solidifies during the subsequent coagulation treatment to form a skeleton structure. The second material serving as a core liquid is non-coagulable, and space occupied by the second material in the initial fiber becomes a channel in the lithium adsorbent. When a lithium adsorbent having a plurality of channels is prepared, a quantity of second flow channels in the nozzle is adjusted, and relative positions of the first flow channel and a plurality of second flow channels are adjusted based on a quantity of channels and a preset size of the lithium adsorbent. In this case, the first flow channel and each second flow channel may be arranged eccentrically.

In this embodiment of the present disclosure, the size of the lithium adsorbent can be adjusted by adjusting parameters such as outlet dimensions of the first flow channel and the second flow channel.

The preparation method has simple steps, high process reliability, high process flexibility, and high production efficiency, and is suitable for large-scale industrial production.

In the preparation method, the solvent is used to dissolve the polymer matrix. The polymer matrix dissolves in the solvent to form a polymer adhesive solution having specific viscosity. The adsorbent particles are dispersed in the polymer solution. In other words, the polymer adhesive solution having specific viscosity is dispersed among the adsorbent particles and functions to bind the adsorbent particles. In this way, in the obtained lithium adsorbent, the adsorbent particles are uniformly dispersed in the skeleton structure. In some specific implementations, the polymer matrix is first mixed with the solvent to obtain the polymer adhesive solution, and then the adsorbent particles are mixed with the polymer adhesive solution to obtain the first material. In this way, a risk of non-uniform dispersion or even agglomeration of the adsorbent particles can be greatly reduced, which avoids a problem such as nozzle clogging, thereby further improving the uniformity of the skeleton structure of the lithium adsorbent, improving the strength of the lithium adsorbent, improving the adsorption efficiency and capacity, and further reducing the pulverization rate of the lithium adsorbent. The polymer adhesive solution and the adsorbent particles may be mixed through stirring, with a stirring rate of 100 rpm to 800 rpm. In some embodiments, the polymer matrix and the solvent are mixed at a temperature ranging from room temperature to 80 °C, preferably from 40 °C to 80 °C. Similarly, the polymer adhesive solution and the adsorbent particles may also be mixed within the foregoing temperature range.

The polymer adhesive solution has specific viscosity, and stirring is usually required during mixing of the adsorbent particles with the polymer adhesive solution, which may cause a bubble in a mixture of the adsorbent particles and the polymer adhesive solution. To remove the bubble and prevent a large quantity of uncontrollable pores from forming in the final lithium adsorbent, in some implementations of the present disclosure, step S01 further includes performing a defoaming treatment on the first material before spinning. In some specific implementations, the defoaming treatment includes: placing the first material in a closed container and performing an evacuation treatment at a pressure of 26 kPa to 200 kPa for duration of 10 min to 30 min.

It is understood that the solvent used in S01 is an organic solvent to dissolve the polymer matrix. In some embodiments, the foregoing solvent includes, but is not limited to, at least one of N-methylpyrrolidone, N,N-dimethylacetamide, N,N-dimethylformamide, tetrahydrofuran, methyl ethyl ketone, dimethyl sulfoxide, carbon tetrachloride, chloroform, dichloromethane, ethyl acetate, or ethanol. A person of ordinary skill in the art may select the solvent based on a specific material of the polymer matrix.

In some implementations of the present disclosure, a mass percentage of the polymer matrix in the polymer adhesive solution is 5% to 13%. In some embodiments, the mass percentage of the polymer matrix in the polymer adhesive solution is 6% to 10%. In this way, the viscosity of the polymer adhesive solution is proper, which facilitates dispersion of the adsorbent particles in the polymer adhesive solution and also improves spinnability of the first material finally obtained. In this embodiment of the present disclosure, the size of the lithium adsorbent can be adjusted by adjusting the polymer matrix in the polymer adhesive solution. For example, the mass percentage of the polymer matrix in the polymer adhesive solution may be, but is not limited to, 5%, 6%, 7%, 8%, 9%, 10%, 11%, 12%, or 13%.

In some implementations of the present disclosure, the adsorbent particles include, but are not limited to, at least one of aluminum-based adsorbent particles, titanium-based adsorbent particles, or manganese-based adsorbent particles. For details, refer to the foregoing related descriptions of the lithium adsorbent. Details are not described herein again. In some implementations of the present disclosure, the D50 particle size of the adsorbent particles 12 is 0.01 μm to 10 μm. In this case, the particle size of the adsorbent particles may be measured by using a laser particle size analyzer.

In some implementations of the present disclosure, the second material contains hydrophilic particles. In some embodiments, the second material is a suspension containing hydrophilic particles. In this way, during preparation of the lithium adsorbent, the inner surface (channel wall) of the lithium adsorbent can be modified with the hydrophilic particles without a need to add an additional process, thereby improving the adsorption efficiency of the lithium adsorbent. In some embodiments, the material of the hydrophilic particles is selected to be the same as the material of the adsorbent particles, and reference may be made to the foregoing content related to the lithium adsorbent. Details are not described herein again. In some embodiments, the D50 particle size of the hydrophilic particles is 0.01 μm to 1 μm. In this case, a particle size of the hydrophilic particle may be measured by using a laser particle size analyzer.

In some implementations of the present disclosure, when the second material contains the hydrophilic particles, the hydrophilic particles may be mixed with a solvent through stirring to obtain the second material. The foregoing solvent includes but is not limited to water. In some embodiments, a mass percentage of the hydrophilic particles in the second material is 0.1% to 5%. In this way, the second material has good fluidity, and the fluidity of the second material has a high matching degree with fluidity of the first material, which facilitates flexible adjustment of the size of the channel in the lithium adsorbent. For example, the mass percentage of the hydrophilic particles in the second material may be, but is not limited to, 0.1%, 0.2%, 0.5%, 1%, 1.5%, 2%, 2.5%, 3%, 3.5%, 4%, 4.5%, 5%, or the like.

In consideration that in some cases, there is a difference in viscosity between the first material and the second material, to better prepare the lithium adsorbent and make the pore structure of the skeleton structure more proper, in some implementations of the present disclosure, during the spinning process in step S02, an extrusion flow rate ratio of the first material to the second material is 1:(1-5). For example, the extrusion flow rate ratio of the first material to the second material may be, but is not limited to, 1:1, 1:1.5, 1:2, 1:2.5, 1:3, 1:3.5, 1:4, 1:4.5, 1:5, or the like.

To improve the spinnability of the first material, a temperature of the first material may be in a range of room temperature to 80 °C. In some embodiments, the temperature of the first material is preferably 40 °C to 60 °C. In this way, the viscosity of the first material is proper, making it easier to control the size of the lithium adsorbent. Further, a temperature of the nozzle during the spinning process is also correspondingly in the range from room temperature to 80 °C, more preferably from 40 °C to 60 °C.

In this embodiment of the present disclosure, a specific spinning process may be any spinning process known in the art suitable for preparing the lithium adsorbent having the size described in this embodiment of the present disclosure, such as wet spinning or dry-jet wet spinning.

In some implementations of the present disclosure, the lithium adsorbent is prepared through wet spinning. In this case, the nozzle is immersed in a coagulation bath, and the initial fiber is extruded directly in the coagulation bath, so that formation and coagulation of the initial fiber occur almost at the same time.

In some cases, during the coagulation process, the solvent is leached out from the initial fiber, and escape paths of the solvent become pores on the surfaces of the skeleton structure of the final lithium adsorbent facing away from the channel and facing the channel. In some embodiments, the formed pores have a pore size of 10 nm to 200 nm. Therefore, the mass percentage of the polymer matrix in the polymer adhesive solution is controlled to be 5% to 10%, which also facilitates the formation of the desired pore structure in the skeleton structure.

In some implementations of the present disclosure, when wet spinning is used, a component of the coagulation bath includes but is not limited to water, or a mixture of water and a solvent. A selection range of the foregoing solvent may be the same as a selection range of the solvent used in step S01, and a solvent component used for the coagulation bath may be the same as or different from that used in step S01.

In some implementations of the present disclosure, a temperature of the coagulation bath is controlled to be within a range from room temperature to 80 °C, and is preferably in a range from room temperature to 40 °C. In this way, formation of the lithium adsorbent is facilitated, and an ideal pore structure is formed in the skeleton structure.

Certainly, in this embodiment of the present disclosure, the dry-jet wet spinning process may alternatively be employed. In other words, the first material and the second material are extruded in air (subjected to an air bath) to obtain the initial fiber, and then the initial fiber is introduced into the coagulation bath. In some implementations of the present disclosure, the nozzle is oriented toward the ground. In this way, gravity can be used to draw the first material, which facilitates the formation of the initial fiber. In some embodiments, a height of the air bath is 5 cm to 30 cm, so that a lithium adsorbent with a target structure is obtained. For example, the height of the air bath may be, but is not limited to, 5 cm, 10 cm, 15 cm, 20 cm, 25 cm, 30 cm, or the like.

It may be understood that a solid material obtained through coagulation treatment is in a shape of a long fiber, and for application of the lithium adsorbent, a cutting treatment is also required. In this embodiment of the present disclosure, to remove residual solvent from the solid material, step S02 further includes washing before cutting. Further, the solid material obtained through coagulation treatment may be sequentially washed and cut. Further, drying may be performed on a material obtained through cutting to obtain the lithium adsorbent. In some embodiments, the solid material obtained through coagulation treatment is washed with water. A mass ratio of water to the solid material is (2-10):1, but is not limited thereto.

The following further describes the technical solutions of the present disclosure by using a plurality of examples.

### Example 1

(1) At 80 °C, a polymer matrix (specifically polyvinylidene fluoride) is dissolved in a solvent (specifically N-methylpyrrolidone) to obtain a polymer adhesive solution. A mass percentage of the polymer matrix in the polymer adhesive solution is 8.8%. The polymer adhesive solution and aluminum-based adsorbent particles (specifically LiCl·2Al(OH)₃·nH₂O) having a D50 particle size of 3.5 μm are mixed at a mass ratio of 1.7:1, stirred at 40 °C, and after thorough mixing, subjected to an evacuation treatment for 30 min to obtain a first material.

(2) The first material and a second material serving as a core liquid are extruded from a nozzle to perform dry-jet wet spinning, with the nozzle oriented toward the ground. The second material is water.

An extrusion flow rate ratio of the second material to the first material is 2:1, and a height of an air bath is 20 cm, to obtain an initial fiber. The initial fiber is introduced into a coagulation bath (specifically water) at 40 °C for a coagulation treatment to obtain a solid material. Then, washing with water (a mass ratio of water to solid material is 10:1) and cutting are performed to obtain a lithium adsorbent having an inner diameter of 0.6 mm, a wall thickness of 0.4 mm, and a length of 1.5 mm. A mass ratio of the adsorbent particles to the polymer matrix in the lithium adsorbent is 20:3. Pores on a surface of a skeleton structure of the lithium adsorbent facing a channel and on a surface of the skeleton structure facing away from the channel have a pore size of 10 nm to 200 nm.

### Example 2

A difference from Example 1 lies in that in step (1), the mass percentage of the polymer matrix in the polymer adhesive solution is 6.0%, and in the first material, the mass ratio of the polymer adhesive solution to the adsorbent particles is 2.5:1; and in step (2), the extrusion flow rate ratio of the second material to the first material is 5:1. A lithium adsorbent having an inner diameter of 0.6 mm, a wall thickness of 0.7 mm, and a length of 1.5 mm is obtained. The mass ratio of the adsorbent particles to the polymer matrix in the lithium adsorbent is 20:3.

### Example 3

The only difference from Example 1 lies in that the second material is a suspension of hydrophilic particles (specifically aluminum-based adsorbent particles with a D50 particle size of 0.2 μm) in a dispersion medium of water, with a mass percentage of the hydrophilic particles in the suspension of 2%. A lithium adsorbent having an inner diameter of 0.6 mm, a wall thickness of 0.4 mm, and a length of 1.5 mm is obtained. The mass ratio of the adsorbent particles to the polymer matrix in the lithium adsorbent is 20:3.

### Example 4

A difference from Example 3 lies in that a mass percentage of the hydrophilic particles in the second material is 6%.

### Example 5

A difference from Example 3 lies in that a shape of the nozzle is changed, and three second flow channels are provided in the nozzle for extrusion of the second material, so that the obtained lithium adsorbent includes the skeleton structure and three channels running in a length direction thereof. A lithium adsorbent having three channels with inner diameters of 0.56/0.54/0.54 mm, corresponding wall thicknesses of 0.23/0.20/0.20 mm, and a length of 1.5 mm is obtained.

### Example 6

A difference from Example 3 lies in that an outer diameter of an inner hole of a spinning head is changed to 0.8 mm, so that the inner diameter of the channel of the lithium adsorbent is 0.7 mm.

### Example 7

A difference from Example 3 lies in that the mass percentage of the polymer matrix in the polymer adhesive solution is reduced to 7.1%, so that the mass ratio of the adsorbent particles to the polymer matrix is 25:3.

### Example 8

A difference from Example 3 lies in that the mass percentage of the polymer matrix in the polymer adhesive solution is reduced to 5.3%, so that the mass ratio of the adsorbent particles to the polymer matrix is 100:9.

### Example 9

A difference from Example 3 lies in that the mass percentage of the polymer matrix in the polymer adhesive solution is increased to 14.7%, so that the mass ratio of the adsorbent particles to the polymer matrix is 4:1.

### Example 10

A difference from Example 3 lies in that the outer diameter of the inner hole of the spinning head is changed to 0.15 mm, so that the inner diameter of the channel of the lithium adsorbent is 0.1 mm.

### Example 11

A difference from Example 3 lies in that the outer diameter of the inner hole of the spinning head is changed to 0.4 mm, so that the inner diameter of the channel of the lithium adsorbent is 0.3 mm.

### Example 12

A difference from Example 3 lies in that an inner diameter of an outer hole of the spinning head is changed to 1.2 mm, so that the wall thickness of the lithium adsorbent is 0.2 mm.

### Example 13

A difference from Example 3 lies in that the inner diameter of the outer hole of the spinning head is changed to 3.0 mm, so that the wall thickness of the lithium adsorbent is 1.0 mm.

### Example 14

A difference from Example 3 lies in that a D50 particle size of the adsorbent particles is 1.5 μm.

### Example 15

A difference from Example 3 lies in that a cutting parameter is changed so that a length of the lithium adsorbent is 4.3 mm.

### Example 16

A difference from Example 3 lies in that the cutting parameter is changed so that the length of the lithium adsorbent is 0.3 mm.

### Example 17

A difference from Example 3 lies in that the mass percentage of the polymer matrix in the polymer adhesive solution is 4%, and pores on the surface of the skeleton structure of the obtained lithium adsorbent facing away from the channel and the surface of the skeleton structure facing the channel have a pore size>200 nm.

To highlight the beneficial effects of the embodiments of the present disclosure, the following comparative examples are set.

### Comparative Example 1

A tubular lithium adsorbent is provided, and a difference from Example 1 lies in that the tubular lithium adsorbent has an inner diameter of 0.05 mm and a wall thickness of 0.15 mm, and a mass ratio of adsorbent particles to a polymer matrix is 37:16.

### Comparative Example 2

A tubular lithium adsorbent is provided, and a difference from Example 1 lies in that the tubular lithium adsorbent has an inner diameter of 0.8 mm and a wall thickness of 1.5 mm, and a mass ratio of adsorbent particles to a polymer matrix is 25:4.

### Parameter Characterization of a Lithium Adsorbent

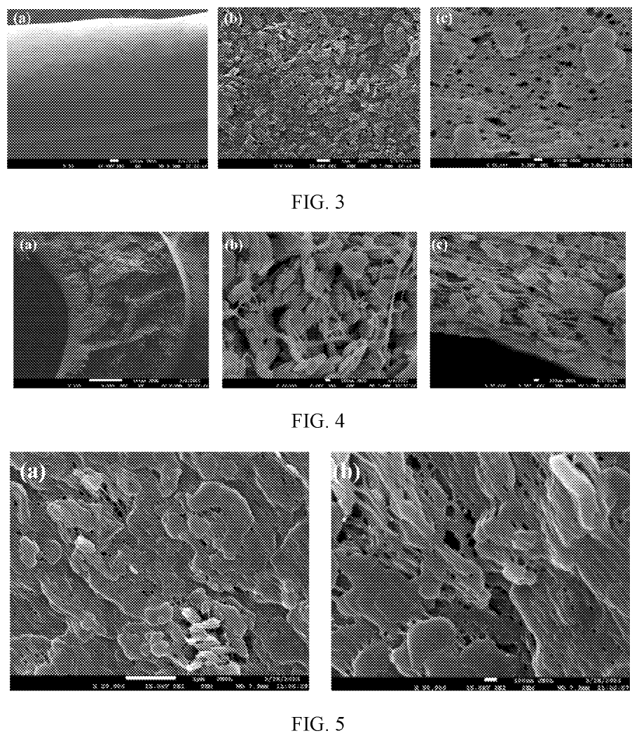

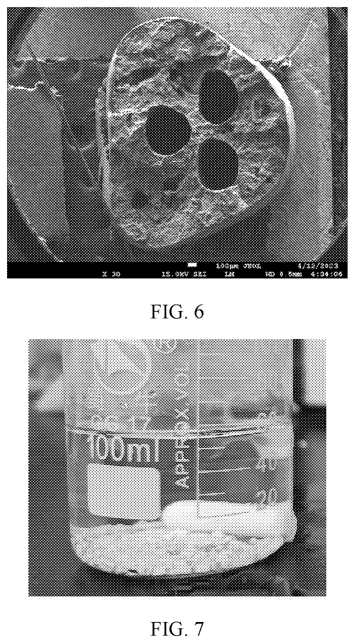

(1) Morphology characterization: The lithium adsorbents of the examples and the comparative examples are subjected to brittle fracture to expose cross sections of the lithium adsorbents. Surface morphology and cross-sectional morphology of the lithium adsorbents of the examples and the comparative examples are observed by using an SEM. SEM photos of inner/outer surfaces and a cross section in Example 3 are shown in FIG. 3 to FIG. 5, and the SEM photo of the cross section in Example 5 is shown in FIG. 6. Inner diameters of channels (if any) and the wall thickness (if any) of the lithium adsorbents of the examples and the comparative examples are measured by using the SEM. Three lithium adsorbent samples are taken for each example and comparative example, and an average value is taken. For the results, refer to the foregoing descriptions of the examples and the comparative examples.

(2) Specific surface area test: A test is performed according to GB/T 19587-2017. Three lithium adsorbent samples are taken for each example and comparative example, and an average value is taken. The results are summarized in Table 1.

(3) Compressive strength: The compressive strength of the lithium adsorbent is measured by using a compressive strength tester. The method is as follows: place a single lithium adsorbent at a center of a lower test head platform, click a test button, and an upper test head automatically descends to perform the test. After the upper test head stops, a deformation rate of the adsorbent is 500. Reading on a screen is the compressive strength of the lithium adsorbent. 50 sets of data are measured, outliers are removed, and an average value is taken. The results are summarized in Table 1.

TABLE 1

| | Specific surface | Compressive |
|---|---|---|
| Experiment | area (m²/g) | strength (N) |
| Example 1 | 17.2371 | 5.2 |
| Example 2 | 20.3113 | 4.1 |
| Example 3 | 18.8334 | 5.3 |
| Example 4 | 19.1161 | 5.2 |
| Example 5 | 17.7445 | 6.2 |
| Example 6 | 18.8212 | 5.0 |
| Example 7 | 19.5513 | 4.5 |
| Example 8 | 19.8414 | 4.0 |
| Example 9 | 20.4187 | 4.2 |
| Example 10 | 19.2535 | 6.6 |
| Example 11 | 19.1886 | 6.3 |
| Example 12 | 18.4433 | 3.6 |
| Example 13 | 19.3666 | 6.1 |
| Example 14 | 18.9992 | 5.3 |
| Example 15 | 18.7163 | 5.5 |
| Example 16 | 19.0149 | 4.8 |
| Example 17 | 19.6116 | 5.0 |
| Comparative example 1 | 17.5274 | 1.3 |
| Comparative example 2 | 19.3114 | 3.7 |

### Brine Adsorption Performance Test

Lithium-containing brine with a high magnesium-to-lithium ratio is taken for testing. A concentration of Li⁺ in the brine is 326 ppm, a concentration of Mg²⁺ is 92910 ppm, and a mass ratio of magnesium to lithium in the brine is 285:1. 10 g of the lithium adsorbent of each example and comparative example is weighed separately. Adsorption is performed at room temperature with a solid-to-liquid ratio of 1:50. The brine is stirred at a stirring rate of 300 rpm, and adsorption time is 90 min. After adsorption, the lithium adsorbent is rinsed during suction filtration, and an amount of water used for rinsing is 200 mL. After rinsing, desorption is performed with pure water at a solid-to-liquid ratio of 1:50, with a stirring rate of 500 rpm, a temperature of 40 °C, and desorption time of 60 min. A concentration of each ion in the solution is measured by using an inductively coupled plasma optical emission spectrometer (ICP-OES). The measured adsorption capacity (adsorption capacity=(concentration of Li⁺ in brine-concentration of Li⁺ in adsorption tail liquid)*brine volume/adsorbent mass) is taken as a working adsorption capacity of the adsorbent. The results are summarized in Table 2.

TABLE 2

| | Concentration | | Concentration | Concentration | | Adsorption |
|---|---|---|---|---|---|---|
| | of Li⁺ in | | of Li⁺ in | of Mg²⁺ in | | capacity |
| | adsorption | Adsorption | desorption | desorption | Magnesium-lithium | after 50 |
| | tail liquid | capacity of | solution | solution | ratio in desorption | cycles |
| Experiment | (ppm) | Li⁺ (mg/g) | (ppm) | (ppm) | solution | (mg/g) |
| Example 1 | 196.40 | 6.48 | 87.51 | 48.31 | 0.55 | 6.35 |
| Example 2 | 171.60 | 7.72 | 103.63 | 92.23 | 0.89 | 7.44 |
| Example 3 | 170.60 | 7.77 | 110.80 | 56.51 | 0.51 | 7.57 |
| Example 4 | 187.80 | 6.91 | 94.20 | 49.93 | 0.53 | 6.66 |
| Example 5 | 180.80 | 7.26 | 98.53 | 98.12 | 1.00 | 6.89 |
| Example 6 | 175.00 | 7.55 | 94.17 | 54.62 | 0.58 | 6.93 |
| Example 7 | 172.00 | 7.70 | 108.00 | 55.08 | 0.51 | 7.35 |
| Example 8 | 200.00 | 6.30 | 85.6 | 132.68 | 1.55 | 6.02 |
| Example 9 | 201.60 | 6.22 | 83.40 | 52.54 | 0.63 | 6.10 |
| Example 10 | 172.20 | 7.69 | 111.80 | 86.09 | 0.77 | 7.58 |
| Example 11 | 171.80 | 7.71 | 111.20 | 58.94 | 0.53 | 7.55 |
| Example 12 | 166.40 | 7.98 | 115.60 | 54.33 | 0.47 | 7.62 |
| Example 13 | 205.40 | 6.03 | 75.60 | 62.75 | 0.83 | 5.71 |
| Example 14 | 202.80 | 6.16 | 77.20 | 38.60 | 0.50 | 5.88 |
| Example 15 | 197.40 | 6.43 | 81.60 | 48.96 | 0.60 | 6.36 |
| Example 16 | 169.20 | 7.84 | 115.80 | 53.27 | 0.46 | 6.25 |
| Example 17 | 174.20 | 7.59 | 109.80 | 79.06 | 0.72 | 7.36 |
| Comparative | 209.20 | 5.84 | 81.80 | 94.07 | 1.15 | 3.62 |
| example 1 | | | | | | |
| Comparative | 235.80 | 4.51 | 64.20 | 142.52 | 2.22 | 4.17 |
| example 2 | | | | | | |

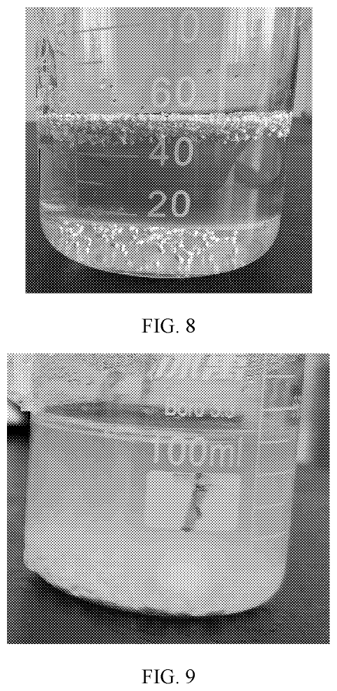

Stability test of a lithium adsorbent in water: 1 g of the lithium adsorbent of each example and comparative example is taken, stirred in 50 mL of water at 40 °C for 2 h (with a stirring rate of 800 rpm), and a morphological change of the lithium adsorbent is observed after standing. The test results of Example 3, Comparative Example 1, and Comparative Example 2 are respectively summarized in FIG. 7 to FIG. 9. In FIG. 7 (Example 3), the lithium adsorbent sinks in water and a solution is clear, which indicates that the lithium adsorbent is wetted in water and has a low pulverization rate. In FIG. 8 (Comparative Example 1), the lithium adsorbent particles float on the water surface, which indicates that this adsorbent has small inner pores, strong hydrophobicity, and is not wetted in water. In FIG. 9 (Comparative Example 2), a solution is very turbid, which reflects a high pulverization rate of this adsorbent. From FIG. 7 to FIG. 9, it can be learned that hydrophilicity and stability of the lithium adsorbent of Example 3 in water are significantly better than those of Comparative Example 1 and Comparative Example 2. In other words, the hydrophilicity is significantly better than that of Comparative Example 1, and the pulverization rate is significantly lower than that of Comparative Example 2.

With reference to parameters in Table 1 and Table 2, it can be learned that the lithium adsorbents provided by the examples of the present disclosure all have better adsorption effect after 50 cycles than the lithium adsorbents of the comparative examples, and comprehensive adsorption effect of the lithium adsorbent of each example is better. It can be learned through comparison between data of Example 1 and data of Example 3 that when the surface of the channel of the lithium adsorbent is attached with hydrophilic particles, it is more conducive to improving the adsorption effect of the lithium adsorbent. Further, it can be learned through comparison between data of Example 3 and data of Example 6 to Example 8 that when the mass ratio of the adsorbent particles to the polymer matrix is within the range suggested by the present disclosure (Example 3, Example 6, and Example 7), the overall performance of the lithium adsorbent is better; and when the foregoing value is within the further suggested range of the present disclosure (Example 3), the adsorption capacity, desorption capacity, magnesium-lithium selectivity ratio, cycling performance and strength of the lithium adsorbent are all better. It can be learned by comparing Example 3, Example 15, and Example 16 that when the length of the lithium adsorbent is within the range suggested by the present disclosure, various properties of the lithium adsorbent are relatively balanced, and the cycling performance is better.

The foregoing descriptions are merely example implementations of this disclosure. It should be noted that a person of ordinary skill in the art can further make several improvements and modifications to this disclosure without departing from the principles of this disclosure, and the improvements and modifications fall within the protection scope of this disclosure.

1. A lithium adsorbent, wherein the lithium adsorbent is tubular and comprises a skeleton structure and one or more channels running in a length direction thereof; an inner diameter of the channel is 0.1 mm to 0.7 mm, and a wall thickness of the lithium adsorbent is 0.2 mm to 1 mm; and the skeleton structure comprises a polymer matrix and adsorbent particles dispersed in the polymer matrix.

2. The lithium adsorbent according to claim 1, wherein a ratio of the inner diameter of the channel to the wall thickness is 1:(0.3-2).

3. The lithium adsorbent according to claim 1, wherein a length of the lithium adsorbent is 0.5 mm to 3 mm.

4. The lithium adsorbent according to claim 1, wherein a surface of the channel is modified with hydrophilic particles, and a D50 particle size of the hydrophilic particles is 0.01 μm to 1 μm.

5. The lithium adsorbent according to claim 4, wherein a material of the hydrophilic particles is the same as a material of the adsorbent particles.

6. The lithium adsorbent according to claim 1, wherein the adsorbent particles are selected from at least one of aluminum-based adsorbent particles, titanium-based adsorbent particles, or manganese-based adsorbent particles; and a D50 particle size of the adsorbent particles is 0.01 μm to 10 μm.

7. The lithium adsorbent according to claim 1, wherein the skeleton structure is a porous structure, and pores on a surface of the skeleton structure facing the channel and on a surface of the skeleton structure facing away from the channel have a pore size of 10 nm to 200 nm.

8. The lithium adsorbent according to claim 1, wherein the polymer matrix comprises at least one of polyvinylidene fluoride, polyvinyl butyral, polyethersulfone, polysulfone, polyacrylonitrile, polyvinyl chloride, polyethylene.

9. The lithium adsorbent according to claim 1, wherein in the lithium adsorbent, a ratio of a total mass of the adsorbent particles to a mass of the polymer matrix is 100:(9-16).

10. The lithium adsorbent according to claim 1, wherein the lithium adsorbent has a BET specific surface area≥17 m²/g.

11. The lithium adsorbent according to claim 1, wherein the lithium adsorbent has a compressive strength≥5 N.

12. A preparation method for the lithium adsorbent according to claim 1, comprising:
mixing the polymer matrix, the adsorbent particles, and a solvent to obtain a first material;
placing the first material and a second material in an accommodating cavity, and performing spinning based on a preset size by using a coaxial spinning process, so that the first material and the second material serving as a core liquid are coaxially extruded to obtain an initial fiber; and
performing a coagulation treatment and cutting on the initial fiber to obtain the lithium adsorbent.

13. The preparation method for the lithium adsorbent according to claim 12, wherein the second material contains hydrophilic particles.

14. The preparation method for the lithium adsorbent according to claim 12, wherein a mass of the polymer matrix is 5% to 13% of a total mass of the polymer matrix and the solvent.

15. The preparation method for the lithium adsorbent according to claim 12, wherein during the spinning process, an extrusion flow rate ratio of the first material to the second material is 1:(1-5).

16. The preparation method for the lithium adsorbent according to claim 12, wherein the coagulation treatment comprises passing the initial fiber through a coagulation liquid; and a temperature of the coagulation liquid is in a range from room temperature to 80 °C.

17. The preparation method for the lithium adsorbent according to claim 12, wherein the second material comprises a substance that is non-coagulable during the spinning process, and the substance that is non-coagulable comprises water.
